(19) United States
(12) Patent Application Publication
(10) Pub. No.: US 2006/0012904 A1
(43) Pub. Date: Jan. 19, 2006

(54) Magnetic disk and magnetic disk device provided with the same

(75) Inventors: Hitoshi Naruse, Musashino-shi (JP); Shigeki Yanagihara, Tokorozawa-shi (JP); Makoto Asakura, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/181,961

(22) Filed: Jul. 15, 2005

(30) Foreign Application Priority Data
Jul. 16, 2004 (JP) 2004-210455

(51) Int. Cl. G11B 5/09; G11B 21/02

(52) U.S. Cl. 360/48; 360/75

(57) ABSTRACT

A magnetic disk of a magnetic disk device includes a flat disk-shaped substrate having a center hole and recording regions provided individually on obverse and reverse surfaces of the substrate. Each of the recording regions includes a data region pattern having a patterned magnetic material shape and a plurality of servo region patterns arranged in given phases in the circumferential direction of the substrate. The servo region patterns of the recording region on the obverse side of the substrate and the servo region patterns of the recording region on the reverse side are shifted in phase from one another.

### CROSS-REFERENCE TO RELATED APPLICATIONS

This application is based upon and claims the benefit of priority from prior Japanese Patent Application No. 2004-210455, filed Jul. 16, 2004, the entire contents of which are incorporated herein by reference.

### BACKGROUND OF THE INVENTION

1. Field of the Invention

This invention relates to a magnetic disk and a magnetic disk device provided with the same.

2. Description of the Related Art

In recent years, magnetic disk devices have been widely used as external recording devices of computers and image recording devices. In general, a magnetic disk device comprises a case in the form of a rectangular box. The case contains a magnetic disk for use as a magnetic recording medium, a spindle motor that supports and rotates the disk, magnetic heads for writing and reading information to and from the disk, and a head actuator that supports the heads for movement with respect to the disk. The case further contains a voice coil motor that rotates and positions the head actuator, a board unit that has a head IC and the like, etc. A printed circuit board for controlling the respective operations of the spindle motor, voice coil motor, and magnetic heads through the board unit is screwed to the outer surface of the case.

Further miniaturization of magnetic disk devices has been advanced so that they can be used as recording devices for a wider variety of electronic apparatuses, or smaller-sized electronic apparatuses in particular. Accordingly, magnetic disks are expected to be further reduced in size and enhanced in recording density. Proposed in Jpn. Pat. Appln. KOKAI Publication No. 2003-22634, for example, is a magnetic disk of the so-called discrete-track-recording (DTR) type, as a magnetic disk that is small-sized and ensures high-density recording. This DTR magnetic disk has rugged surfaces, and a magnetic material that can record data is formed on the rugged surfaces. Projections are mad previously to form patterns, including a plurality of servo region patterns to which servo data are recorded and a data region pattern to which a user can record data.

In the DTR magnetic disk, the servo region patterns and the data region pattern have different irregularity ratios. For example, the projections of the servo region patterns account for 40%, while those of the data region pattern account for 70%. In this case, a dynamic pressure that is generated between a slider for lifting the magnetic heads and the magnetic disk surface varies depending on the irregularity ratios per unit area. The lift of the magnetic heads varies between the servo region patterns and the data region pattern. Thus, a pressure on the magnetic heads changes at the boundaries between the servo region patterns and the data region pattern, so that an impulsive force is generated to act on the magnetic heads.

The actuator vibrates if such a force acts on the magnetic heads. Possibly, therefore, the positioning accuracy of the heads may be lowered, and noises may be produced. In increasing the recording capacity, in particular, a recording layer should preferably be provided on each surface of the magnetic disk. If this is done, however, vibrations of the magnetic heads on the obverse and reverse sides of the disk sometimes may resonate with each other, thereby generating a substantial exciting force in the head actuator. In this case, the actuator vibrates considerably, so that the head positioning accuracy is lowered and noises are produced, inevitably.

### BRIEF SUMMARY OF THE INVENTION

According to an aspect of the invention, there is provided a magnetic disk comprising: a disk-shaped substrate having a center hole; and recording regions provided individually on obverse and reverse surfaces of the substrate and each including a data region pattern having a patterned magnetic material shape and a plurality of servo region patterns arranged in given phases in the circumferential direction of the substrate. The servo region patterns of the recording region on the obverse side and the servo region patterns of the recording region on the reverse side are shifted in phase from one another.

According to another aspect of the invention, there is provided a magnetic disk device comprising: a magnetic disk including a disk-shaped substrate having a center hole and recording regions provided individually on obverse and reverse surfaces of the substrate; a drive unit which supports and rotates the magnetic disk at a constant speed; a head which performs information processing for the magnetic disk; and a head actuator which radially moves the head with respect to the magnetic disk.

The recording regions of the magnetic disk includes a data region pattern having a patterned magnetic material shape and a plurality of servo region patterns arranged in given phases in the circumferential direction of the substrate, the servo region patterns of the recording region on the obverse side and the servo region patterns of the recording region on the reverse side being shifted in phase from one another,
the magnetic disk being located in a direction such that each of the servo region patterns and a movement path of the head on the magnetic disk are in line with each other.

### BRIEF DESCRIPTION OF THE SEVERAL VIEWS OF THE DRAWING

FIG. 1A is a plan view showing a surface pattern of a magnetic disk according to an embodiment of the invention;

FIG. 1B is a plan view showing a reverse pattern of the magnetic disk;

FIG. 2 is an enlarged perspective view, partially in section, showing a data region pattern of the magnetic disk;

FIG. 3 is a diagram typically showing a servo region pattern of the magnetic disk;

FIG. 4 is a sectional view schematically showing the magnetic disk;

FIG. 5 is a sectional view typically showing positional relationships between the magnetic heads and the patterns of the magnetic disk;

FIGS. 6A, 6B, 6C, 6D, 6E, 6F and 6G are sectional views individually showing manufacturing processes for the magnetic disk;

FIG. 7 is an exploded perspective view showing an HDD according to the embodiment of the invention;

FIG. 8 is a block diagram schematically showing a configuration of the HDD;

FIG. 9 is a diagram illustrating head positioning control in the HDD;

FIG. 10 is a diagram illustrating address detection processing in a channel of the HDD;

FIG. 11A is a diagram showing a force applied to a magnetic head on the obverse side of the magnetic disk;

FIG. 11B is a diagram showing a force applied to a magnetic head on the reverse side of the magnetic disk;

FIG. 11C is a diagram showing the sum of the forces applied to the magnetic heads on the obverse and reverse sides of the magnetic disk;

FIG. 12A is a diagram showing a force applied to a magnetic head on the obverse side of a magnetic disk according to another embodiment of the invention;

FIG. 12B is a diagram showing a force applied to a magnetic head on the reverse side of the magnetic disk according to the second embodiment; and

FIG. 12C is a diagram showing the sum of the forces applied to the magnetic heads on the obverse and reverse sides of the magnetic disk according to the second embodiment.

### DETAILED DESCRIPTION OF THE INVENTION

A magnetic disk according to an embodiment of this invention will now be described in detail with reference to the accompanying drawings.

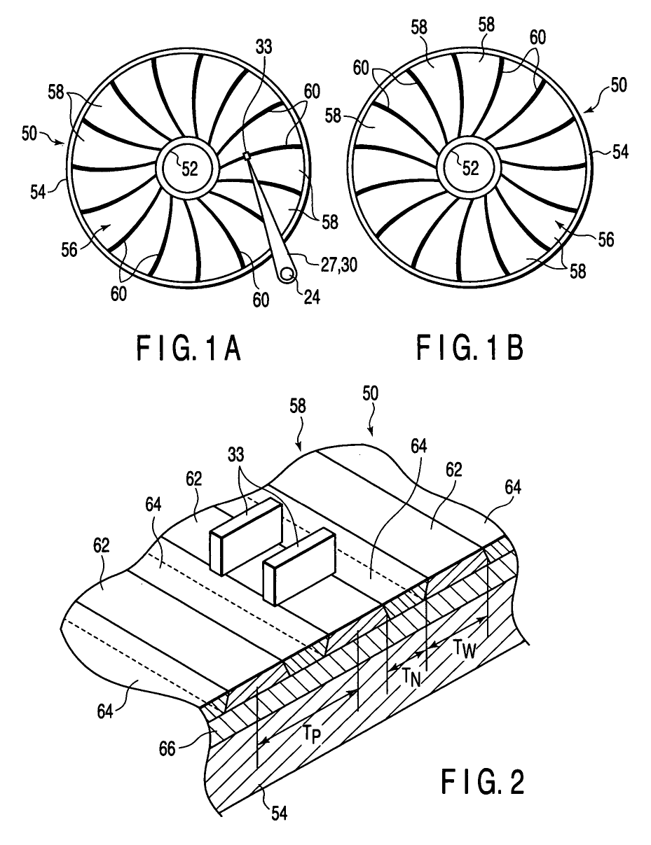

As shown in FIGS. 1A, 1B and 2, a magnetic disk 50 according to the present embodiment comprises a substrate 54 in the form of a flat disk having a center hole 52 and recording layers 56 formed on at least one surface of the substrate (obverse and reverse surfaces of the substrate in this case). Each of the recording layers 56, which constitutes a recording region, has the form of a ring that coaxially covers all the area of the substrate 54 except its inner and outer peripheral edge portions. Each recording layer 56 is formed of a ferromagnetic material, e.g., CoCrPt, and is patterned. Those regions of the layer which have no magnetic material are filled with a nonmagnetic material, e.g., SiO₂. Thus, the resulting magnetic disk has a leveled surface and serves for perpendicular magnetic recording.

The magnetic disk 50 is formed as a DTR medium. FIG. 1A shows a pattern of the recording layer 56 on the obverse side of the disk 50. FIG. 1B shows a pattern of the layer 56 on the reverse side of the disk 50. Roughly speaking, each pattern of the recording layer 56 includes a data region pattern 58 and a plurality of servo region patterns 60.

As shown in the enlarged view of FIG. 2 that illustrates a part of the magnetic disk 50, the substrate 54 is formed of glass, for example, and has a substrate layer (SUL) 66 on each of its obverse and reverse surfaces. The substrate 54 may be formed of aluminum in place of glass. The data region pattern 58 and the servo region patterns 60 are lapped on each substrate layer 66.

The data region pattern 58 forms a recording region where user data are recorded and reproduced by heads of a magnetic disk device (mentioned later), and is composed of projections of a magnetic material on the surface of the substrate 54. More specifically, the data region pattern 58 has a plurality of circular ring-shaped magnetic tracks 62 that serve as perpendicular recording layers of a ferromagnetic material (CoCrPt). These magnetic tracks 62 are arranged substantially coaxially with the center hole 52 and side by side at predetermined periods or track pitches Tp in the radial direction of the substrate 54.

The magnetic tracks 62 that adjoin in the radial direction are divided by nonmagnetic guard belt portions 64 in the form of recesses to which data cannot be recorded. According to the present embodiment, a nonmagnetic implant material, e.g., SiO₂, is implanted in the nonmagnetic guard belt portions 64 in order to level the disk surface. A thin diamond-like carbon protective film is formed on the magnetic disk surface, and it is coated with a lubricant. A protective layer may be formed directly on the irregular surface without embedding the guard belt portions 64 in the surface.

A radial width Tw of each magnetic track 62 that extends in the radial direction of the substrate 54 is larger than a width TN of each nonmagnetic guard belt portion 64. In the present embodiment, the ratio of the radial width of each magnetic track to that of each nonmagnetic guard belt portion is 2:1, and the data region pattern 58 has a magnetic occupancy of 67%. Since the data region pattern 58 has a high track density exceeding 120 kTPI, for example, the radial pattern period (track pitch) Tp is shorter than a visible light wavelength. Thus, a rainbow pattern that is formed by light diffraction by the magnetic tracks 62 cannot be visually recognized in the magnetic disk 50.

As shown in FIGS. 1A and 1B, the ring-shaped magnetic tracks 62 that constitute the data region pattern 58 are sectored in the circumferential direction of the substrate 54 by the servo region patterns 60. The servo region patterns 60 are located in a given phase in the circumferential direction of the substrate 54. In FIGS. 1A and 1B, the servo region patterns 60 are shown to divide the data region pattern 58 in fifteen sectors. Actually, however, the data region pattern 58 is divided in 100 servo sectors or more.

Each servo region pattern 60 is a prebit region in which necessary information for positioning the heads of the magnetic disk device is implanted in a magnetic or nonmagnetic manner. Each servo region pattern 60 has an arcuate shape that extends substantially radially from the center hole 52 of the substrate 54 to the outer peripheral edge portion and coincides with a movement path of the heads. Each servo region pattern 60 is a circumferentially extended pattern such that its circumferential length along the circumference of the substrate 54 increases in proportion to the radial position on the substrate, that is, a region on the outer peripheral side of the substrate is longer. The servo region patterns 60 of the obverse-side recording layer 56 of the substrate 54 and the servo region patterns 60 of the reverse-side recording layer 56 are arranged in different orders in the circumferential direction. For example, the patterns on the obverse side are arranged in the counterclockwise direction, and those on the reverse side in the clockwise direction. Thus, the recording regions of the magnetic disk 50 have patterned magnetic material shapes, one on the obverse side and another on the reverse.

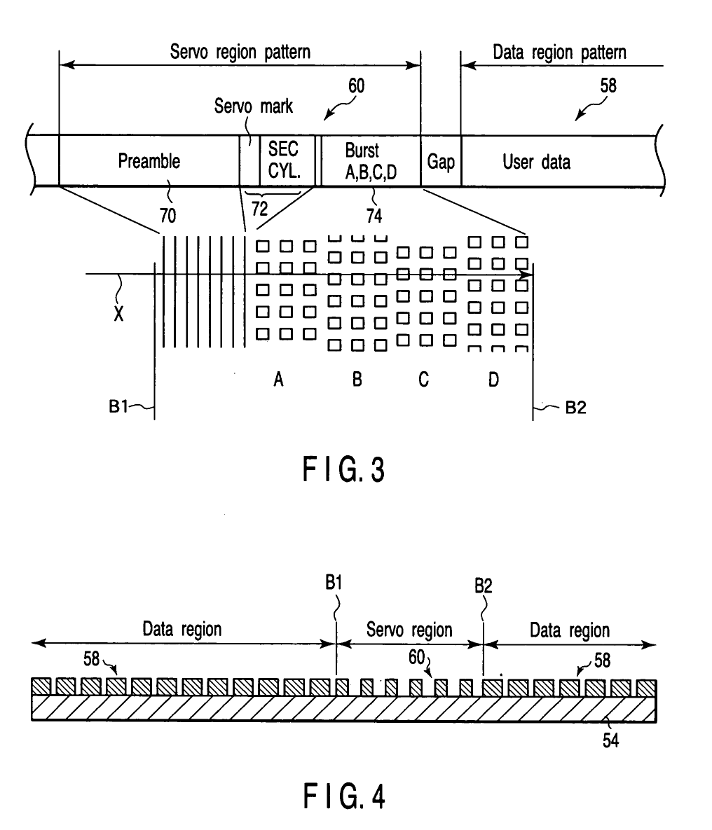

One of the servo region patterns 60 will now be described in detail with reference to FIG. 3.

FIG. 3 shows the servo region pattern 60 that is provided on the obverse side of the magnetic disk 50. This servo region pattern 60 is a pattern in a position where the heads pass from left to right of FIG. 3 in a passing direction X when the magnetic disk 50 is set in a drive. If the pattern 60 is represented by an arcuate servo region pattern shape, circular arcs on the outer and inner peripheral sides are situated on the left- and right-hand sides, respectively, of FIG. 3. The data region pattern 58 is located on either side of the servo region pattern 60. An outer peripheral circular arc of each servo region pattern 60, compared with the data region pattern 58, forms a first boundary B1 that is situated on the upstream side with respect to the rotation direction of the magnetic disk, while an inner peripheral circular arc forms a second boundary B2 that is situated on the upstream side with respect to the rotation direction.

Roughly speaking, the servo region pattern 60 has a preamble portion 70, an address portion 72, and a burst portion 74 for deviation detection. Like the data region pattern 58, it is composed of magnetic patterns formed of ferromagnetic projections and nonmagnetic patterns formed of recesses between the magnetic patterns. The recesses are filled with the nonmagnetic implant material.

The preamble portion 70 is provided to perform PLL processing and AGC processing. In the PLL processing, clocks for servo signal reproduction are synchronized with time delays that are caused by rotation eccentricity or the like of the magnetic disk 50. The AGC processing serves to maintain an appropriate signal reproduction amplitude. The preamble portion 70 is formed as a repetitive pattern region that is substantially radially continuous at least in the radial direction of the substrate 54 and includes magnetic and nonmagnetic portions arranged alternately in the circumferential direction of the substrate. The magnetic-nonmagnetic ratio of the preamble portion 70 is substantially 1:1, that is, its magnetic occupancy is about 50%. The circumferential repetition period, which varies in proportion to the radial distance, is not longer than the visible light wavelength even in an outermost peripheral portion of the substrate 54. As in the case of the data region pattern, it is hard to identify the servo region pattern by light diffraction.

In the address portion 72, a servo signal recognition code called a servo mark, sector information, cylinder information, etc. are formed in Manchester codes that are arranged at the same pitches as the circumferential pitches of the preamble portion 70. The cylinder information has a pattern such that it changes with every servo track. In order to lessen the influence of a mistake in address reading during head seek operation, therefore, the information is Manchester-encoded and recorded after code conversion is performed such that variations from adjacent tracks called Gray codes are minimal. The magnetic occupancy of the address portion 72 is about 50%.

The burst portion 74 is an off-track detection region for detecting an off-track deviation from an on-track state of a cylinder address. This region is formed with four marks or bursts A, B, C and D whose pattern phases are shifted in radial directions. Each burst has a plurality of marks that are arranged at the same pitch periods as the preamble portion in the circumferential direction. A radial period is proportional to the change period of an address pattern, that is, to a servo track period. In the present embodiment, each burst is formed for 10 periods in the circumferential direction. In the radial direction, its patterns are repeated with a period twice as long as the servo track period. The magnetic occupancy of A, B, C and D burst patterns is about 75%.

Basically, each mark is designed for a rectangle, or more strictly, a parallelogram based on a skew angle at the time of head access. Depending on the machining performance, such as the stamper working accuracy, transfer formation, etc., however, the marks are somewhat rounded. Further, the marks are formed as nonmagnetic portions.

A detailed description of the principle of position detection based on the burst portion 74 is omitted. The off-track deviation is calculated by arithmetically processing an average amplitude value of reproduction signals for the burst portions A, B, C and D. Although the A, B, C and D burst patterns are used in the present embodiment, they may be replaced with conventional phase difference servo patterns or the like that are arranged as off-track detecting means. However, the magnetic occupancy of the phase difference servo patterns is about 50%.

In the DTR magnetic disk 50 described above, as shown in FIG. 4, the irregularity ratio varies between each servo region pattern 60 and the data region pattern 58. For example, the projection ratio of the servo region patterns 60 is 40%, while that of the data region pattern 58 is 70%.

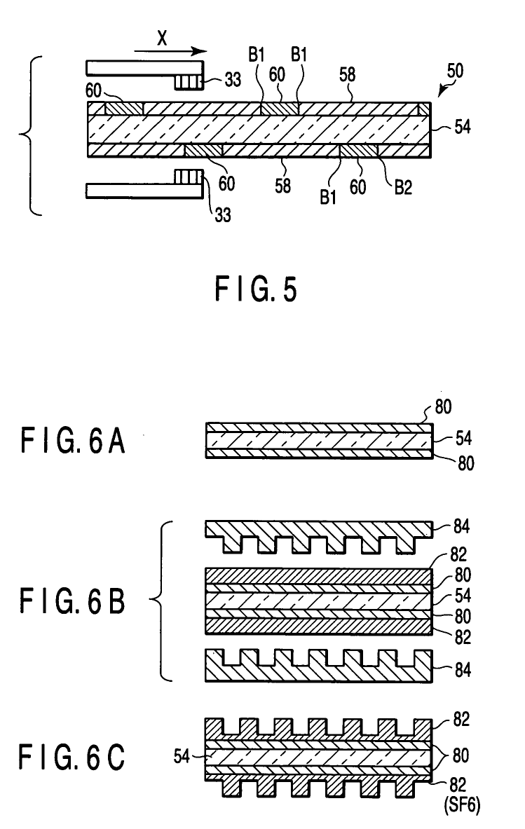

As shown in FIG. 5, the servo region patterns 60 on the obverse side of the substrate 54 and the servo region patterns 60 on the reverse side are shifted in phase from one another. In the present embodiment, each of the servo region patterns 60 on the obverse side of the substrate 54 is located opposite a region between each two adjacent servo region patterns 60 on the reverse side of the substrate 54, that is, a position intermediate between two adjacent servo region patterns 60 in the circumferential direction of the substrate 54. The servo region patterns 60 on the obverse side of the substrate 54 and the servo region patterns 60 on the reverse side are arranged alternately in the circumferential direction of the substrate 54 without overlapping one another in the axial direction of the substrate.

The following is a description of a method of manufacturing the magnetic disk 50 described above. Manufacturing processes include a transfer process, a magnetic processing process, and a finishing process.

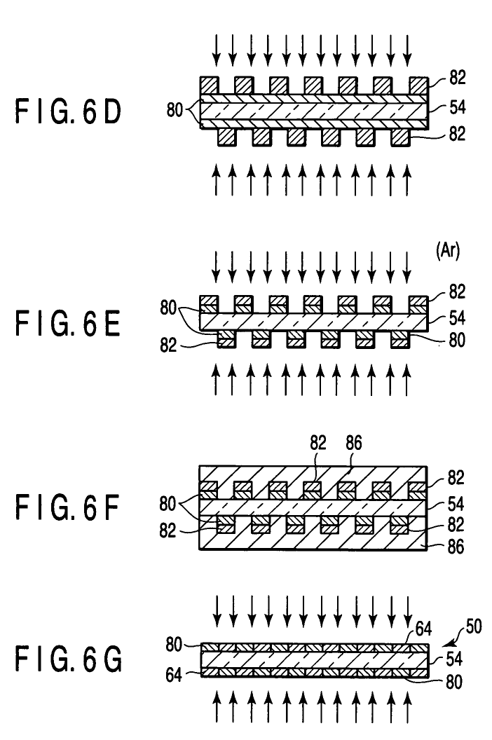

As shown in FIG. 6A, the substrate 54 of glass or silicon is first prepared, substrate layers are formed individually on the opposite sides of the substrate, and magnetic layers 80 of a ferromagnetic material are further formed overlapping the substrate layers. The substrate size may be selected from a wide range of 0.85 to 3 inches. Carbon protective films for oxidation prevention are formed to a thickness of about 4 nm on top of the magnetic layers 80. As shown in FIG. 6B, resists 82 are spread individually on the magnetic layers 80 by the SOG (spin-on-glass) process. For example, SiO₂ is used for the resists 82, and preferably, its coating thickness should be 120 nm or thereabout.

Subsequently, a stamper 84 that constitutes a base of a pattern used in the transfer process is prepared. A manufacturing process for the stamper 84 can be divided into steps of drawing, development, electroforming, and finishing. In the pattern drawing, a part of the magnetic disk to be demagnetized is exposed for drawing from its inner periphery to outer periphery on a resist-coated matrix by using an electron beam exposure unit of a matrix-rotation type. The resulting structure is subjected to development, RIE, etc. to form a matrix with irregular patterns. After this matrix is treated for electrical conductibility, its surface is electroformed with nickel. Subsequently, the nickel is separated from the matrix, and the disk-shaped stamper 84 of nickel is formed by punching inside and outside edges. The stamper 84 has projections on those parts which are to be demagnetized. Stampers 84 for the obverse and reverse surfaces of the magnetic disk are formed individually.

In the transfer process, as shown in FIGS. 6B and 6C, the irregularities of the stampers 84 are transferred to the resists 82 on the opposite surfaces of the magnetic disk by the imprint lithography using an imprinter of a synchronous double-sided transfer type. More specifically, the substrate 54 having the resists 82 formed thereon is chucked by its center hole 52 as their opposite surfaces are sandwiched between the stampers 84 of two types that are prepared for the reverse and obverse surfaces, and the whole substrate surfaces are pressed uniformly. Thereupon, the irregular patterns of the stampers 84 are transferred to the surfaces of the resists 82. By the transfer process, the parts to be demagnetized are formed as recesses of the resists 82.

Both surfaces of the substrate are imprinted by means of the stampers 84 lest the phases of the servo region patterns on the obverse and reverse surfaces of the substrate be coincident. As shown in FIG. 5, the servo region patterns on the obverse and reverse sides in the shifted phases are arranged alternately in the circumferential direction of the substrate without overlapping one another. This phase shift is set optionally.

After the resists 82 to which the irregular patterns are transferred are then subjected to UV irradiation, they are baked at about 160° C. Thereupon, the resists 82 are cross-linked to become hard enough to resist ion milling.

In an irregularity forming process based on imprinting, resist residues remain at the bottom of the pattern recesses. Less resist residues are preferred in magnetic material processing. If the resist residues are too little, however, the shape transferability based on the imprinting worsens.

As shown in FIG. 6D, RIE using SF6 gas, for example, is used to remove the resist residues. Low-pressure, high-density plasma source RIE can be suitably used to remove the residues without failing to minimize the change of the irregular shapes transferred to the resists 82. Preferably, an inductively coupled plasma (ICP) or electron cyclotron resonance (ECR) etching apparatus should be used for this purpose. The residues are removed by SF6 RIE at an etching pressure of about 2 mTorr in the ICP etching apparatus. The carbon protective films on the magnetic layers 80 are also separated simultaneously at irregular groove portions.

Then, in the magnetic processing process, the magnetic layer surfaces of the parts to be demagnetized are exposed after the residual resists at the respective bottoms of the recesses of the resists 82 are removed. At those parts where the magnetic layers 80 are to be left, the resists 82 are formed as projections. Then, only those parts of the magnetic layers 80 which are situated corresponding to the recesses are removed by Ar-ion milling using the resists 82 as guard layers, whereby the magnetic material is worked into desired patterns, as shown in FIG. 6E. In order to eliminate damage to the magnetic layers 80, as this is done, the angle of ion incidence for etching is varied to 30 and 70 degrees so as to suppress redeposition. As the redeposition is suppressed, sidewalls of projection patterns are inclined at about 40 to 75 degrees.

Then, the resists 86 of SiO₂ as a nonmagnetic material are applied individually to a sufficient thickness to the opposite surfaces of the magnetic disk by, for example, SOG, as shown in FIG. 6F, whereby the irregularities of the disk surfaces are removed. The thickness of the SiO₂ film is about 150 nm (T-7) or 90 nm (FOX) after the material is shaken off by spinning at 4,000 rpm. Thereafter, etching-back is performed by milling so that the magnetic layers 80 are exposed, as shown in FIG. 6G. The surface roughness (Ra) of the etched-back medium is adjusted to 0.6 nm by using an etching rate of 0.1 nm/sec for etching. This etch-back process, like the removal of the residues of the SOG film, can be performed by means of the ICP etching apparatus using the SF6 gas.

Thus, the patterned magnetic disk is obtained having the recesses filled with the nonmagnetic material and leveled. The magnetic disk surfaces can be made substantially level by this leveling processing. However, the medium must be etched back so that the magnetic layers 80 are securely exposed to the surfaces, so that fine irregularities are left even after the leveling processing.

In the final finishing process, the disk surfaces are polished further to improve the levelness, and the carbon protective film is formed thereafter. The magnetic disk according to the present embodiment is completed by further application of the lubricant.

The following is a description of a hard disk drive (HDD) as the magnetic disk device that is provided with the magnetic disk 50 described above.

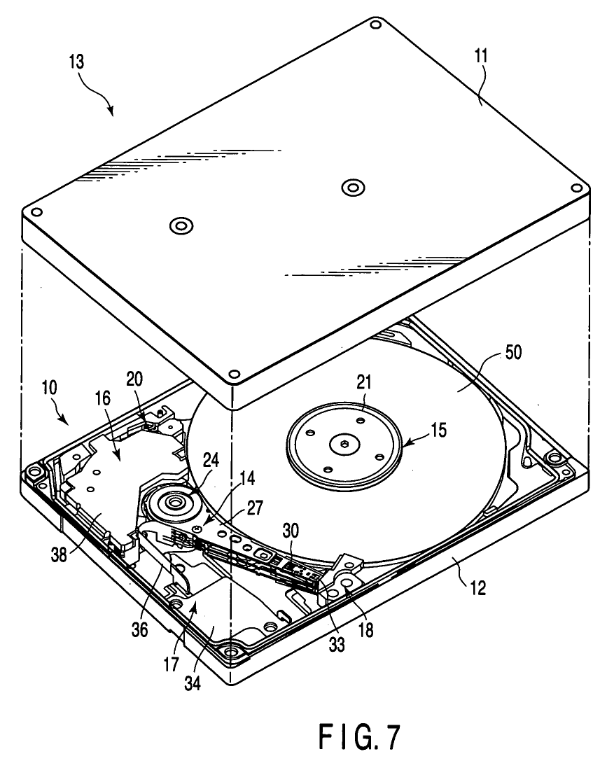

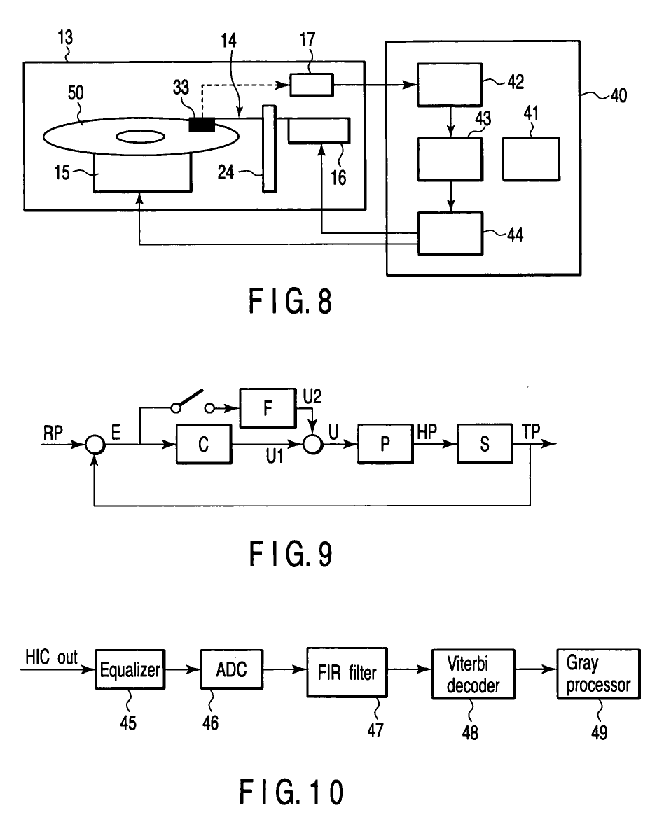

As shown in FIGS. 7 and 8, a magnetic disk device 10 comprises a flat, rectangular disk enclosure 13. The enclosure 13 has a box-shaped base 12 and a top cover 11 that hermetically closes a top opening of the base 12.

The disk enclosure 13 contains the magnetic disk 50, a spindle motor 15, magnetic heads 33, and a head actuator 14. The spindle motor 15 supports and rotates the disk. The magnetic heads 33 are used to record and reproduce information to and from the disk. The head actuator 14 supports the magnetic heads for movement with respect to the magnetic disk 50. The enclosure 13 further contains a voice coil motor (hereinafter, referred to as a VCM) 16, a ramp load mechanism 18, an inertia latch mechanism 20, and a flexible printed circuit board unit (hereinafter, referred to as an FPC unit) 17. The VCM 16 rotates and positions the head actuator. The ramp load mechanism 18 holds the magnetic heads in a position off the magnetic disk when the heads are moved to the outermost periphery of the disk. The inertia latch mechanism 20 holds the head actuator in a shunt position. The FPC unit 17 is mounted with circuit components, such as a preamplifier. The base 12 has a bottom wall, and the spindle motor 15, head actuator 14, VCM 16, etc. are arranged on the inner surface of the bottom wall.

As mentioned before, the magnetic disk 50 is a small-diameter patterned medium with a perpendicularly magnetized dual-film structure, both surfaces of which are processed for DTR. More specifically, the disk 50 has recording layers 56 on its obverse and reverse surfaces. It is formed having a diameter of 1.8 or 0.85 inch. The magnetic disk 50 is coaxially fitted on a hub (not shown) of the spindle motor 15 and fixed to the hub by a clamp spring 21. The magnetic disk 50 is supported and rotated at a given speed by the spindle motor 15 as a driver unit.

The head actuator 14 has a bearing portion 24 fixed on the bottom wall of the base 12, two arms 27 attached to the bearing portion, and suspensions 30 extending individually from the arms. The magnetic heads 33 are supported individually on the respective extended ends of the suspensions 30. The arms 27, suspensions 30, and heads 33 are supported for rotating motion around the bearing portion 24. As shown in FIG. 5, the paired heads 33 include a down-head that faces the obverse-side recording layer of the magnetic disk 50 and an up-head that faces the reverse-side recording layer of the disk. In each magnetic head 33, a slider for use as a head body is mounted with a magnetic head element that includes a read element (GMR element) and a write element.

As shown in FIGS. 7 and 8, the VCM 16 has a voice coil attached to the head actuator 14, a pair of yokes 38 fixed to the base 12 and opposed to the voice coil, and a magnet (not shown) fixed to one of the yokes. The VCM 16 generates a rotational torque around the bearing portion 24 in the arms 27 and moves the magnetic heads 33 in the radial direction of the magnetic disk 50.

The FPC unit 17 has a rectangular board body 34 that is fixed on the bottom wall of the base 12. Electronic components, connectors, etc. are mounted on the board body. The FPC unit 17 has a belt-shaped main flexible printed circuit board 36 that electrically connects the board body 34 and the head actuator 14. The magnetic heads 33 that are supported by the head actuator 14 are connected electrically to the FPC unit 17 through a relay FPC (not shown) and the main flexible printed circuit board 36.

As mentioned before, the magnetic disk 50 has the obverse and reverse sides and is set in the base 12 with the obverse and reverse sides aligned so that the head movement path of the magnetic disk device is substantially coincident with the arcuate shape of the servo region patterns 60 of the magnetic disk. The specifications of the magnetic disk 50 fulfill outside and inside diameters, recording and reproducing characteristics, etc. that are adaptive to the magnetic disk device. Each arcuate servo region pattern 60 has its center of a circular arc on the circumference of a circle that is concentric with the magnetic disk and has its radius equivalent to the distance from the rotation center of the magnetic disk to the center of the bearing portion 24 of the head actuator 14. The radius of the circular arc is equivalent to the distance from the bearing portion 24 to the head element of each magnetic head 33. In other words, each servo region pattern 60 has the shape of a circular arc that is always substantially coincident with the head movement path even when the magnetic rotates. The radius of the circular arc of each servo region pattern 60 is equivalent to the distance from the bearing portion 24 to each magnetic head 33. The center of the circular arc moves along a circular path that is concentric with the magnetic disk and varies in synchronism with the angle phase on the disk on which the patterns are formed. The radius of the path of the center of the circular arc is equivalent to the distance from the center of the spindle motor 15 to the center of the bearing portion 24.

A printed circuit board (PCB) 40 for controlling the respective operations of the spindle motor 15, VCM 16, and magnetic heads through the FPC unit 17 is fixed to the outer surface of the bottom wall of the base 12, and faces the base bottom wall.

As shown in FIG. 8, a large number of electronic components are mounted on the PCB 40. These electronic components mainly include four system LSI's, a hard disk controller (HDC) 41, a read/write channel IC 42, an MPU 43, and a motor driver IC 44. The PCB 40 is mounted with a connector that can be connected to a connector on the side of the FPC unit 17 and a main connector for connecting the HDD to an electronic apparatus such as a personal computer.

The MPU 43 is a controller of a drive operating system and includes a ROM, RAM, CPU, and logic processor, which realize a positioning control system according to the present embodiment. The logic processor is an arithmetic processor composed of a hardware circuit and is used for high-speed arithmetic processing. Further, operating software (FW) is saved in the ROM, and the MPU controls the drive in accordance with this FW.

The HDC 41 is an interface section in the HDD. It exchanges information with an interface between the disk drive and a host system, e.g., a personal computer, the MPU 43, the read/write channel IC 42, and the motor driver IC 44, thereby managing the whole HDD.

The read/write channel IC 42 is a head signal processor associated with read/write operation. It is composed of a circuit that switches channels of a head amplifier IC and processes recording and reproducing signals, such as read/write signals. The motor driver IC 44 is a drive unit for the VCM 16 and the spindle motor 15. It drivingly controls the spindle motor for constant rotation and applies a VCM manipulated variable from the MPU 43 as a current value to the VCM, thereby driving the head actuator 14.

A configuration of a head positioning controller will now be described in brief with reference to FIG. 9.

FIG. 9 is a block diagram of the head positioning controller. In FIG. 9, symbols C, F, P and S individually designate transfer functions of the system. Specifically, a control object P is equivalent to the head actuator 14 that includes the VCM 16, while a signal processor S is an element that is realized by a channel IC and an MPU (part of off-track detecting means).

A control processor is composed of a feedback controller C (first controller) and a synchronous suppression/compensation section (second controller), and specifically, is realized by an MPU.

The operation of the control processor will be described in detail later. The signal processor S generates track current position (TP) information on the magnetic disk in accordance with a reproducing signal including address information from the servo region patterns 60 right under a head position (HP). Based on a target track position (RP) on the magnetic disk 50 and a position error (E) between the target track position and a current position (TP) of each magnetic head 33 on the magnetic disk, the first controller C outputs an FB control value U1 in a direction to lessen the position error.

The second controller F is an FF compensation section for correcting the shape of the magnetic track on the magnetic disk 50, vibration that is synchronous with the disk rotation, etc. It saves a previously calibrated rotation synchronous compensation value in a memory table. Normally, the second controller F never uses the position error (E), and outputs an FF control value U2 based on servo sector information (not shown) from the signal processor S with reference to the table. The control processor adds up the respective outputs U1 and U2 of the first and second controllers C and F, and supplies the resulting value as a control value U to the VCM 16 through the HDC 41, thereby driving the magnetic heads 33.

The rotation synchronous compensation value table is calibrated in an initial stage of operation. If the position error (E) becomes larger than a preset value, the table starts to be calibrated again, whereupon the synchronous compensation value is updated.

An operation for detecting the position error by the reproducing signal will now be described in brief with reference to FIG. 9.

The magnetic disk 50 is rotated at a fixed rotational speed by the spindle motor 15. The magnetic heads 33 are elastically supported by gimbals that are attached to the suspensions 30. They are designed to float with a fine gap above the magnetic disk surface, balanced by an air pressure that is generated as the disk rotates. Thus, a head reproducing element can detect a magnetic flux leakage from the disk magnetic layer with a given magnetic gap above the disk surface.

As the magnetic disk 50 rotates, its servo region patterns 60 pass right under the magnetic heads 33 in a given period. Fixed-period servo processing can be executed by detecting track position information from reproducing signals for the servo region patterns.

Once the HDC 41 recognizes one of servo region pattern identification flags called servo marks in the servo region patterns 60, the timing for the arrival of each servo region pattern can be anticipated, since the servo marks are arranged at predetermined intervals. Accordingly, the HDC 41 urges the channel to start servo processing when the preamble portion 70 comes right under the magnetic heads.

The following is a description of an address reproduction processing configuration in the channel. As shown in FIG. 10, an output signal from a head amplifier IC (HIC) that is connected to the magnetic heads 33 is read by the channel IC. After it is subjected to longitudinal signal equalization by an analog filter as an equalizer 45, the signal is sampled as a digital value by an ADC 46.

A magnetic field leakage from the magnetic disk 50 is perpendicular magnetization and is a magnetic/nonmagnetic pattern. However, DC offset components are thoroughly removed by the high-pass characteristic of the HIC and equalizer processing of a front-stage portion of the channel IC for longitudinal equalization. Thus, an analog filter post-output from the preamble portion 70 is substantially a false sine wave. A difference from a conventional perpendicular magnetic medium lies in that the signal amplitude is halved.

The magnetic disk 50 according to the present embodiment is not limited to a patterned medium. However, selection of the direction of the magnetic flux leakage of the servo region patterns may cause misidentification of 1 or 0, and hence, failure in code detection in the channel. Thus, the magnetic disk polarity can be properly set according to the magnetic flux leakage of the patterns.

In the channel IC, the processing is switched depending on its reproducing signal phase. A reproducing signal clocks are synchronized with medium pattern periods in pull-in processing. Sector cylinder information is read in address reading processing. Burst portion processing is carried out as necessary information for off-track detection.

A detailed description of the pull-in processing is omitted. In this processing, the timing for sampling the ADC is synchronized with a sine-wave reproducing signal, and AGC processing is performed to adjust the signal amplitudes of digital sample values to a certain level. Periods 1 and 0 of a disk pattern are sampled at four points.

Then, in reproducing the address information, noises of the sample valued are lowered by a FIR filter 47. The sample values are converted into sector information and track information through Viterbi decoding processing based on maximum likelihood estimation by a Viterbi decoder 48 or gray code reverse conversion by a gray processor 49. Thus, servo track information of the magnetic heads 33 can be obtained.

Subsequently, in the burst portion 74, the channel proceeds to off-track detection processing. The signal amplitudes are subjected to sample-hold integral processing in the order of the burst signal patterns A, B, C and D, and a voltage value equivalent to an average amplitude is outputted to the MPU 43, whereby a servo processing interrupt is issued to the MPU. On receiving this interrupt, the MPU 43 reads the burst signals in the time series by an internal ADC, and converts them into off-track values by DSP. Based on these off-track values and the servo track information, the servo track positions of the magnetic heads 33 are detected precisely.

According to the magnetic disk 50 and the HDD constructed in this manner, the servo region patterns 60 on the obverse side of the magnetic disk 50 and the servo region patterns 60 on the reverse side are arranged with a phase shift. Thus, the vibration level of the head actuator 14 in the seek-on-track state of the magnetic heads can be lowered, so that the head positioning accuracy can be improved.

More specifically, as shown in FIG. 5, the magnetic heads 33 are kept off the surfaces of the magnetic disk 50 by an air current that is produced as the disk rotates when they read or write data from or to the disk. In the HDD that has the plurality of magnetic heads 33, the heads are paired on the obverse and reverse sides of the single magnetic disk 50. The upper and lower magnetic heads 33 rotate simultaneously as the head actuator 14 rotates.

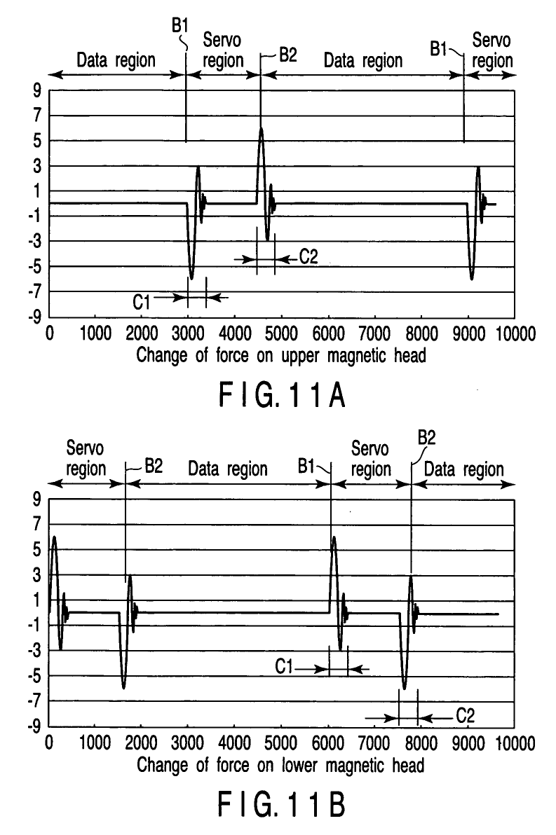

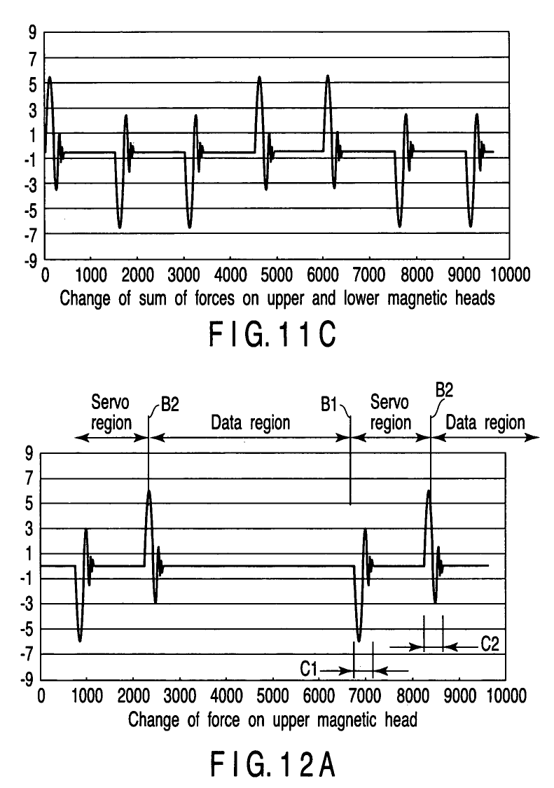

The lift of each magnetic head 33 above each magnetic disk surface depends on the irregularity ratio per unit area of the disk surface. This is because dynamic pressures that are generated between the magnetic disk surfaces and the slider that lifts the heads 33 are different. In the case of the present embodiment, as mentioned before, the projection ratio of the servo region patterns 60 is 40%, while that of the data region pattern 58 is 70%. The data region pattern 58 generates a higher dynamic pressure, which ensures a larger lift of the magnetic heads 33. Therefore, the pressure on the magnetic heads 33 varies between the first and second boundaries B1 and B2 between the servo region patterns 60 and the data region pattern 58. FIGS. 11A and 11B show changes of forces that act on the upper and lower magnetic heads, individually. As seen from these drawings, an impulsive force is generated to act on the upper and lower heads 33 as the heads pass through the boundaries B1 and B2.

Urged by the force that is generated during the passage of the boundary B1, the upper and lower magnetic heads 33 repeatedly vibrate in a first vibration generating region C1 that includes the boundary B1 or a starting position for the servo region patterns 60. Likewise, the heads 33, urged by the force that is generated during the passage of the boundary B2, repeatedly vibrate in a second vibration generating region C2 that includes the boundary B2 or an ending position for the servo region patterns 60.

According to the present embodiment, the servo region patterns 60 on the obverse side of the magnetic disk 50 and the servo region patterns 60 on the reverse side are arranged with a phase shift. Therefore, each of the servo region patterns 60 on the obverse side is located opposite an intermediate position between each two adjacent servo region patterns 60 on the reverse side without overlapping the servo region patterns 60 on the reverse side. Thus, the first and second vibration generating regions C1 and C2 on the obverse side of the magnetic disk are shifted in circumferential position lest they never overlap their counterparts on the reverse side.

After a residual exciting force that results from the impulsive force applied to one of the magnetic heads 33 is thoroughly removed, as shown in FIGS. 11A and 11B, another impulsive force independently acts on the other magnetic head 33 at another timing. As shown in FIG. 11C, therefore, the upper and lower magnetic heads 33 can never be simultaneously subjected to any impulsive force. Accordingly, there is no possibility of the respective vibrations of the upper and lower magnetic heads resonating with each other and developing into a substantial vibration. In consequence, a force that acts on the head actuator 14 can never become larger than a force that acts on each magnetic head 33. Thus, the magnetic heads 33 can be steadily positioned with high accuracy by the head actuator 14.

Reducing the vibration level of the head actuator 14 is effective to lower the noise level of the HDD. Further, fundamental vibration frequency components that are in an audible range and easily audible are lessened, while high-frequency components that are outside or nearly outside the audible range and cannot be easily heard by the human ear are enhanced. Thus, the level of unfavorable noises can be lowered. The fundamental vibration frequency is 12,000 Hz in the case of an HDD in which the servo region patterns 60 are embedded in 100 sectors throughout the circumference of the magnetic disk that is rotated at 7,200 rpm (120 Hz), for example. If the servo region patterns 60 are shifted in phase in the aforesaid manner, however, the level of the fundamental frequency component (12,000 Hz) lowers, while that of a high-order component rises. Since components of 20 kHz are outside the audible range, however, the general noise level lowers.

According to the magnetic disk 50 and the HDD described above, each servo region pattern 60 of the magnetic disk is formed in the shape of a circular arc corresponding to the magnetic head movement path. This is advantageous to the seek performance and the prevention of lowering of SN ratios at the inner and outer peripheries of the disk, so that the performance of the magnetic disk device can be improved.

A DTR system is a magnetic recording system in which error rates in data regions can be improved and the surface recording density can be increased. The increased recording density leads to an increase in recording capacity. Since the servo information, along with data tracks, is formed by implantation, the medium never requires servo track write (STW), which is an advantage of the use of the patterned medium to the HDD.

More specifically, the magnetic disk 50 has the arcuate servo region patterns 60 that depend on the configuration of the HDD, and its obverse and reverse are oriented as it is incorporated in the HDD. Accordingly, the magnetic disk 50 can produce the following functions and effects.

First, the magnetic disk 50 can ensure high seek performance. As mentioned before, the HDC 41 requests the channel to start serve processing at a timing when any of the servo region patterns 60 comes right under the magnetic heads 33. If the servo region patterns are arranged at equal spaces and if the magnetic heads 33 are fixed in the radial direction, the resulting timing error is within an allowable range and negligible despite some fluctuation of a servo region pattern crossing period that is attributable to eccentric mounting of the magnetic disk. However, the magnetic heads 33 move in a circular arc as they move at high speed in the radial direction of the magnetic disk 50 during seek operation, for example. Thus, the magnetic heads move in the circumferential direction as well as in the radial direction and arouse a problem.

If the servo region patterns are formed perfectly radially, for example, they are situated in fixed angle phases without depending on the radial position. Since the magnetic heads 33 also move in the circumferential direction, however, the angle phases vary with respect to the rotation center of the spindle motor 15. Thus, a servo starting phase (distance from a servo region starting position in which a reproducing head is situated when a servo gate is booted) as viewed from the magnetic head side changes. This phase difference is settled depending on the seek speed, error in the magnetic head path, and control period. If the phase difference exceeds an allowable range, it is hard to fetch servo signals at the preamble portion 70. Possibly, therefore, the servo mark (SAM) at the head of the address portion 72 may fail to be detected, thus resulting in a servo loss error.

The occurrence of the servo loss error can be prevented even during high-speed seek operation by estimating a timing error time from the seek speed and the cylinder information and correcting a servo gate rise time from the HDC 41. In this case, however, the servo characteristic is changed by a fluctuation of the control period, so that the seek performance lowers inevitably. Forming the servo region patterns in a circular arc after the head movement path can be regarded as an effective and indispensable factor to enable high-speed seek.

Secondly, the difference in the servo information detection SN between the inner and outer peripheries of the magnetic disk 50 can be reduced. The servo information detection SN at the inner periphery of the disk 50 is inevitably lowered due to a high linear recording density even though the servo region patterns 60 are arranged along the magnetic head movement path. If the servo region patterns are perfectly radial, however, the SN ratio on the inner peripheral side of the magnetic disk lowers drastically. A simulation indicates that the SN ratio at the outer peripheral portion of the disk also lowers. This is attributable to the skew angle of the magnetic heads. More specifically, the servo signals are applied with a skew to the magnetic heads, so that the build-up of the servo signals is degraded and entails a reduction of the amplitude.

In the case of a small-diameter magnetic disk, in particular, servo signal clocks are enhanced to a maximum in order to increase the format efficiency. Accordingly, lowering of the SN ratio at the innermost periphery of the magnetic disk directly influences address reading, off-track detection accuracy, etc. As in the present embodiment, therefore, the shapes of the servo region pattern 60 that advance parallel to the magnetic heads 33 are essential. In the present embodiment, prebid-length signal clocks of the servo region patterns are set in accordance with the circumferential length of the visually recognizable patterns, the detection SN at the inner peripheral portion of the magnetic disk, and the rotational speed of the spindle motor.

This invention is not limited directly to the embodiment described above, and its components may be embodied in modified forms without departing from the scope or spirit of the invention. Further, various inventions may be made by suitably combining a plurality of components described in connection with the foregoing embodiment. For example, some of the components according to the foregoing embodiment may be omitted. Furthermore, components according to different embodiments may be combined as required.

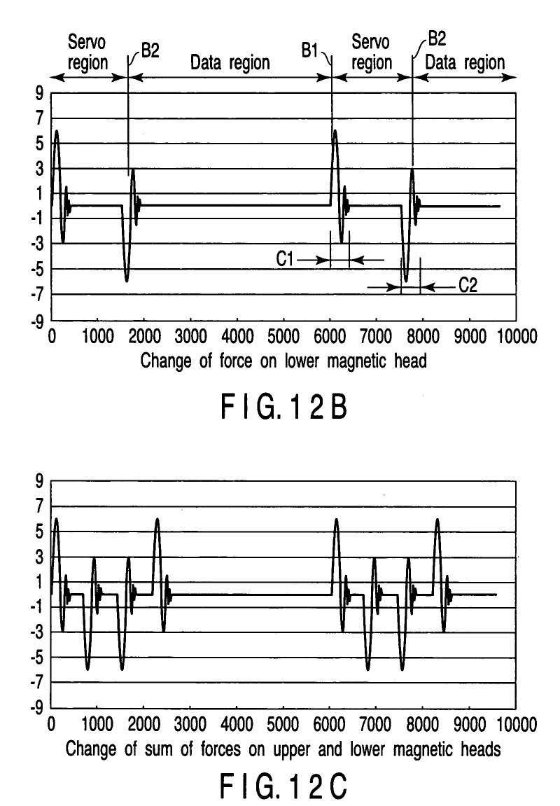

In the foregoing embodiment, the servo region patterns on the obverse side of the magnetic disk are located with a shift in the circumferential direction of the substrate from the servo region patterns on the reverse side of the disk without overlapping them. Alternatively, however, the servo region patterns on the obverse and reverse sides of the magnetic disk may be arranged partially overlapping one another. FIG. 12A shows a force applied to servo regions and data regions on the obverse side of the magnetic disk and the upper magnetic head. FIG. 12B shows a force applied to servo regions and data regions on the reverse side of the disk and the lower magnetic head. FIG. 12C shows change of the sum of the forces applied to the upper and lower magnetic heads. As seen from FIGS. 12A to 12C, each servo region pattern 60 on the obverse side of the magnetic disk is shifted in the circumferential direction of the substrate 54 from each corresponding servo region pattern on the reverse side. If this is done, the first vibration generating region C1 in which a residual exciting force attributed to the first boundary B1 is generated and the second vibration generating region C2 in which a residual exciting force attributed to the second boundary B2 is generated overlap neither of the first and second vibration generating regions C1 and C2 on the reverse side of the magnetic disk. The same functions and effects of the foregoing embodiment can be also obtained from this arrangement.

Each servo region pattern 60 on the obverse side of the magnetic disk may be located with a shift in the circumferential direction of the substrate 54 lest a region that accounts for 50% or more of its preamble portion 70 in its width direction overlap the preamble portion 70 of each corresponding servo region pattern on the reverse side of the disk. The same functions and effects of the foregoing embodiment can be also obtained from this arrangement.

The projection rates of the data region pattern and the servo region patterns are not limited to the figures according to the foregoing embodiment but may be varied if necessary. Further, the number of magnetic disk(s) in the HDD is not limited to one but may be increased as required.

What is claimed is:

1. A magnetic disk comprising:
a disk-shaped substrate having a center hole; and
recording regions provided individually on obverse and reverse surfaces of the substrate and each including a data region pattern having a patterned magnetic material shape and a plurality of servo region patterns arranged in given phases in the circumferential direction of the substrate,
the servo region patterns of the recording region on the obverse side and the servo region patterns of the recording region on the reverse side being shifted in phase from one another.

2. The magnetic disk according to claim 1, wherein the servo region patterns extend substantially radially from the center hole side of the substrate to an outer peripheral edge portion thereof and divide the data region pattern in a plurality of parts in the circumferential direction of the substrate, and the servo region patterns and the data region pattern are formed of irregular patterns such that a ratio of projections in the servo region patterns is different from a ratio of projections in the data region pattern.

3. The magnetic disk according to claim 1, wherein each of the servo region patterns of the recording region on the obverse side is located opposite a region between each two adjacent servo region patterns on the recording region on the reverse side.

4. The magnetic disk according to claim 1, wherein each of the servo region patterns has a first boundary situated on the downstream side of the data region pattern with respect to the direction of rotation of the substrate and a second boundary situated on the upstream side with respect to the rotation direction, each of the recording regions having a first vibration generating region attributed to the first boundary and a second vibration generating region attributed to the second boundary, and each of the servo region patterns on the obverse side is located with a shift from each corresponding servo region pattern on the reverse side in the circumferential direction of the substrate lest the first and second vibration generating regions on the obverse side overlap the first and second vibration generating regions on the reverse side.

5. The magnetic disk according to claim 1, wherein each of servo region patterns includes a preamble portion, an address portion, and a burst portion arranged in the circumferential direction of the substrate, and each of servo region patterns on the obverse side is located with a shift in the circumferential direction of the substrate lest a region which accounts for 50% or more of the preamble portion in the width direction thereof overlap the preamble portion of each corresponding servo region pattern on the reverse side.

6. The magnetic disk according to claim 1, wherein each of servo region patterns has a radius larger than the radius of the outermost periphery of the substrate and a center of a circular arc on a circular path concentric with the substrate, and is formed so that a circumferential length thereof along the circumstance of the substrate increases with distance from the center.

7. The magnetic disk according to claim 1, wherein the data region pattern and the servo region patterns have a large number of projections of a magnetic material and recesses which magnetically divide the projections, the recesses being filled with a nonmagnetic implant material.

8. A magnetic disk device comprising:
a magnetic disk including a disk-shaped substrate having a center hole and recording regions provided individually on obverse and reverse surfaces of the substrate;
a drive unit which supports and rotates the magnetic disk at a constant speed;
a head which performs information processing for the magnetic disk; and
a head actuator which radially moves the head with respect to the magnetic disk,
the recording regions of the magnetic disk including a data region pattern having a patterned magnetic material shape and a plurality of servo region patterns arranged in given phases in the circumferential direction of the substrate, the servo region patterns of the recording region on the obverse side and the servo region patterns of the recording region on the reverse side being shifted in phase from one another,
the magnetic disk being located in a direction such that each of the servo region patterns and a movement path of the head on the magnetic disk are in line with each other.

9. The magnetic disk device according to claim 8, wherein the servo region patterns extend substantially radially from the center hole side of the substrate to an outer peripheral edge portion thereof and divide the data region pattern in a plurality of parts in the circumferential direction of the substrate, and the servo region patterns and the data region pattern are formed of irregular patterns such that a ratio of projections in the servo region patterns is different from a ratio of projections in the data region pattern.

10. The magnetic disk device according to claim 8, wherein each of the servo region patterns of the recording region on the obverse side is located opposite a region between each two adjacent servo region patterns on the recording region on the reverse side.
